(19) United States
(12) Patent Application Publication
(10) Pub. No.: US 2026/0138473 A1
(43) Pub. Date: May 21, 2026

(54) TWO POINTS ACCESS ELECTRIC VEHICLE CHARGER CABINET

(71) Applicant: Xuong Thien Tran, West Covina, CA (US)

(72) Inventor: Xuong Thien Tran, West Covina, CA (US)

(21) Appl. No.: 18/950,274

(22) Filed: Nov. 18, 2024

(51) Int. Cl. B60L 53/30; B60L 53/14; H02B 1/30; H02B 1/38; H02B 1/44

(52) U.S. Cl. CPC B60L 53/30; B60L 53/14; H02B 1/301; H02B 1/38; H02B 1/44

(57) ABSTRACT

The invention provides a two points access electric vehicle charger cabinet designed to be installed within a wall opening, allowing users to charge from both the wall's interior and exterior. This charging cabinet includes an external component with a frame-shaped main body featuring inner and outer openings. An external cover is hinged to this frame and can open and close as needed. Inside, an assembly body connects to the frame's inner side, supporting an internal box that is also hinged and contains an accommodating space for a charger. When users need to charge from inside, they open the inner cabinet to access the charger, while exterior access involves opening the outer cover to retrieve the charger. This design offers a more convenient charging solution.

### BACKGROUND OF THE DISCLOSURE

### Technical Field

The present disclosure relates to the field of charging technology, specifically to a two points access electric vehicle charger cabinet that enables users to conveniently charge from both a driveway and inside a garage.

### Description of the Related Art

Currently, home charging solutions for electric vehicles are generally divided into a few types to meet various user needs. The first type is a basic charging method that uses a standard 110V household outlet, which usually requires no additional setup. This method is suitable for overnight charging but has a slower rate, adding only about 3-5 miles of range per hour. The second type is a more advanced charging option that requires a dedicated 240V power source and installation of a specialized charging station. With a higher output, this station significantly increases charging speed, adding approximately 20-30 miles of range per hour, making it the most popular home charging choice, especially for users needing faster charging speeds. However, charging stations also have limitations, making them less flexible in use.

One notable inconvenience is that these charging stations offer unidirectional, fixed-position charging. Typically installed in garages or on fixed walls, their charging range is limited by cable length, which makes it challenging to charge vehicles parked in different locations. For example, if the charging station is installed inside a garage, it cannot reach vehicles parked outside, and vice versa. This setup inconveniences many users and reduces charging flexibility.

Furthermore, if the charging station is installed outdoors, additional protective measures are needed in rainy or cold weather, adding further inconvenience. In summary, although charging stations offer an efficient charging solution, their fixed, unidirectional design limits charging flexibility for various parking arrangements, requiring more planning and consideration from users in daily charging routines.

To address these issues, the inventors have developed a two points access electric vehicle charger cabinet to effectively solve the shortcomings of current charging solutions.

### SUMMARY OF THE DISCLOSURE

It is a primary objective of the present disclosure to provide a two points access electric vehicle charger cabinet that allows users to perform charging operations both from the interior and exterior of a wall-mounted charging station. This design effectively enhances the flexibility of electric vehicle charging and offers a simple and convenient user experience.

To achieve the aforementioned objective, the present disclosure discloses a two points access electric vehicle charger cabinet, configured to be installed in an opening of a wall, allowing a user to perform charging operations from either the interior or exterior side of the wall, comprising: an external component, comprising: a frame-like main body, configured to be installed in the opening of the wall, and having a first side and a second side disposed oppositely, wherein the first side has an inner opening, and the second side has an outer opening, with the first side facing the interior surface of the wall when the frame-like main body is installed in the wall opening; and an external cover, pivotally installed on the second side and capable of opening and closing relative to the frame-like main body; and an internal component, assembled to the first side of the external component, comprising: an assembly body, having a frame-like structure configured to assemble with the first side; and an internal box, pivotally installed on the assembly body and capable of opening and closing relative to the assembly body, the internal box having a accommodating space for accommodating a charger; wherein, when the user performs charging from the interior side of the wall, the internal box is opened to access the charger; when the user performs charging from the exterior side of the wall, the external cover is opened to retrieve the charger located in the internal box for charging. This setup provides enhanced flexibility, enabling convenient and quick charging from either side of the wall, making it an innovative addition to EV charging equipment.

In another embodiment, wherein at least one first guide rail is installed within the accommodating space, and the charger is secured to the first guide rail by at least one screw, allowing the charger to be stably installed within the inner cabinet.

In yet another embodiment, the first guide rail has a T-shape, allowing the screw to slide within the first guide rail, thereby accommodating chargers of any brand, different sizes, and shapes.

In one embodiment, at least one first guide rail and at least one second guide rail are installed within the accommodating space, with the second guide rail being fixed to the inner surface of the internal box. The first guide rail is assembled onto the second guide rail in a staggered arrangement, allowing the first guide rail to move along the second guide rail, and the charger is secured to the first guide rail by at least one screw, thereby enhancing flexibility in installing chargers.

Furthermore, based on the aforementioned embodiment, the first guide rail has a T-shape, allowing the screw to slide within the first guide rail to adjust the fixed position according to the shape and size of the charger.

Preferably, in another embodiment, the opposite side of the internal box, which is pivotally connected to the assembly body is equipped with a switch assembly, and the assembly body has a corresponding latch component; the switch component includes a base and an elastic pressing member, where the base is fixed to the internal box, and one side of the elastic pressing member is pivotally connected to the base; the elastic pressing member hooks onto the latch component, securing the internal box in a closed state, and can be released from the latch component when pressed, allowing the internal box to open, thus enabling users to quickly and conveniently open and close the inner cabinet.

In one embodiment, the bottom side of the second side includes a cable guide structure, which extends from the bottom side of the second side and includes a guide groove to temporarily secure the charging cable of the charger within the guide groove during charging, facilitating the stable positioning of the charger's cable.

Furthermore, in another embodiment, the bottom side of the external cover has a perforation corresponding to the guide groove, allowing the charger's cable to pass through. This enables the charger to be used even when the outer cover is closed.

Preferably, the external cover is equipped with a lock to lock onto the frame-like main body when the external cover is closed. This structural feature enhances the security of the charger during storage.

In a better application example, the top side of the internal box includes a wire hole located near the pivotal connection between the internal box and the assembly body, allowing the charger's power cable to be extended outward and electrically connected to an external power source. With the placement of the cable hole, when the internal box is rotated open, the power cable of the charger only undergoes minimal rotation, reducing the likelihood of cable twisting and damage.

Additionally, in one embodiment, the internal box and the assembly body are pivotally connected through at least one hinge component, which includes a movable plate and a pivot shaft, with the pivot shaft installed on the internal box; one end of the movable plate is fitted onto the pivot shaft, and the other end is fixed to the assembly body, enabling the pivot shaft and the movable plate to pivot relative to each other, allowing the pivot shaft and movable plate to rotate relative to each other.

In another embodiment, it is disclosed that the internal box is made from a metal material that is magnetically attractable, allowing it to be used in conjunction with magnets installed on the inner wall of the wall. This ensures that the internal box will not be affected by movement during charging.

In one embodiment, the inner bottom surface of the frame-like main body slopes from the inner opening side towards the outer opening side, so that when water enters, it is directed outward to protect the charger.

Preferably, the periphery of the second side includes a waterproof frame, designed to fit against the outer wall surface, so as to direct rainwater away from the Two points access electric vehicle charger cabinet, for example, during rainfall.

Additionally, in one embodiment, the inner surface of the external cover is equipped with a waterproof gasket, structured in a frame-like shape to press against the edge of the outer opening when the external cover is closed. When the outer cover is closed, the seal strip compresses against the outer edge of the open side of the body, enhancing the waterproof effect.

To prevent the wires from being damaged due to heat, preferably, the top side of the internal box includes a ventilation structure, and the bottom side includes an air intake structure, allowing hot air to be discharged from the top while cold air enters from the bottom. Furthermore, the ventilation structure includes a plurality of ventilation holes, and the air intake structure includes a plurality of air intake holes.

Additionally, in one embodiment, it is disclosed that the edge of the internal box opening has a protective structure, which is frame-shaped and extends from the edge of the internal box opening, with the thickness gradually increasing outward to protect the charger.

In one embodiment, the external cover is pivotally connected to the frame-like main body through at least one pivot member and includes a baffle; the baffle extends from the edge of the external cover, with one side of the pivot member connected to the baffle and the other side connected to the second side, allowing the pivot member to be hidden between the baffle and the frame-like main body, allowing the pivot member to be concealed.

In another embodiment, the periphery of the assembly body includes a fixed frame designed to be secured against the inner wall surface, thereby enhancing the assembly stability of the two points access electric vehicle charger cabinet with the wall.

In summary, the two points access electric vehicle charger cabinet of the present invention breaks through the limitations of traditional unidirectional charging methods, offering users high flexibility and safety. It provides easy access to charging equipment on both the interior and exterior sides, supporting charging from both the inside of a garage and operation from the driveway, allowing for convenient charging in various parking scenarios. Additionally, the internal box's guide rails and the further T-shaped structure design with movable screws enable it to accommodate chargers of any size or shape, making it adaptable to different charger brands or sizes, ensuring flexible installation. The external components also feature a structure that hides the pivot components and a waterproof frame, offering both aesthetic appeal and practicality, while ensuring safe use in various weather conditions. The venting and intake designs effectively prevent overheating, extending the life of charging equipment and ensuring the stability and safety of the charging process. Users can also securely fix the internal box onto the wall using magnets, based on the material characteristics of the box, preventing excessive movement of the charging cables during charging and effectively reducing the risk of wear and damage. The external cover provides reliable protection through the lock structure. The robustness and flexibility of the switch component further demonstrate the product's outstanding performance in terms of safety. With this comprehensive protection and flexible operation, the charging cabinet not only serves as a storage solution for electric vehicle charging equipment but also enhances the user experience during daily use. It represents a significant improvement and upgrade over existing technologies.

### BRIEF DESCRIPTION OF THE DRAWINGS

FIG. 1A is a structure schematic view of an external component in accordance with a preferred embodiment of the present disclosure;

FIG. 1B is a structure schematic view of an internal component in accordance with a preferred embodiment of the present disclosure;

FIG. 2 is an application schematic view of a two points access electric vehicle charger cabinet in accordance with a preferred embodiment of the present disclosure;

FIG. 3 is a partial structure schematic view of an internal box in accordance with a preferred embodiment of the present disclosure;

FIG. 4 is a structure schematic view of a switch component in accordance with a preferred embodiment of the present disclosure;

FIG. 5 is an application schematic view of a two points access electric vehicle charger cabinet which is used from the inner side of the wall in accordance with a preferred embodiment of the present disclosure;

FIG. 6A is a first application schematic view of a two points access electric vehicle charger cabinet which is used from the outer side of the wall in accordance with a preferred embodiment of the present disclosure;

FIG. 6B is a second application schematic view of a two points access electric vehicle charger cabinet which is used from the outer side of the wall in accordance with a preferred embodiment of the present disclosure.

FIG. 7 is a structure schematic view of an external component which is closing in accordance with a preferred embodiment of the present disclosure;

### DETAILED DESCRIPTION OF THE PREFERRED EMBODIMENTS

The technical characteristics of the present disclosure will become apparent in the following detailed description of the preferred embodiment with reference to the accompanying drawings. The dimensions, proportions, sizes, shapes, or application states depicted in the figures are for illustrative purposes only to explain the technical features of the invention. They do not represent actual structural designs, as explicitly stated herein.

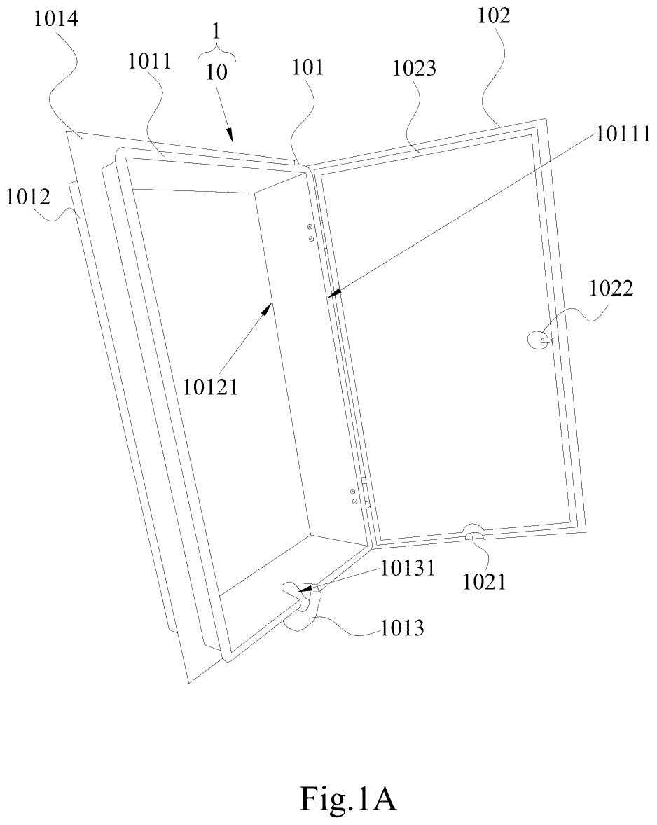

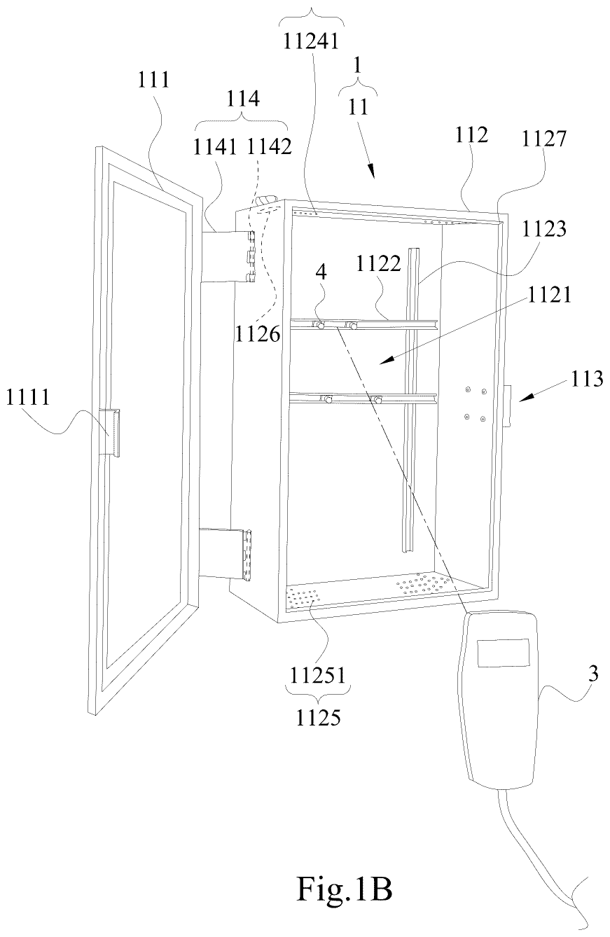

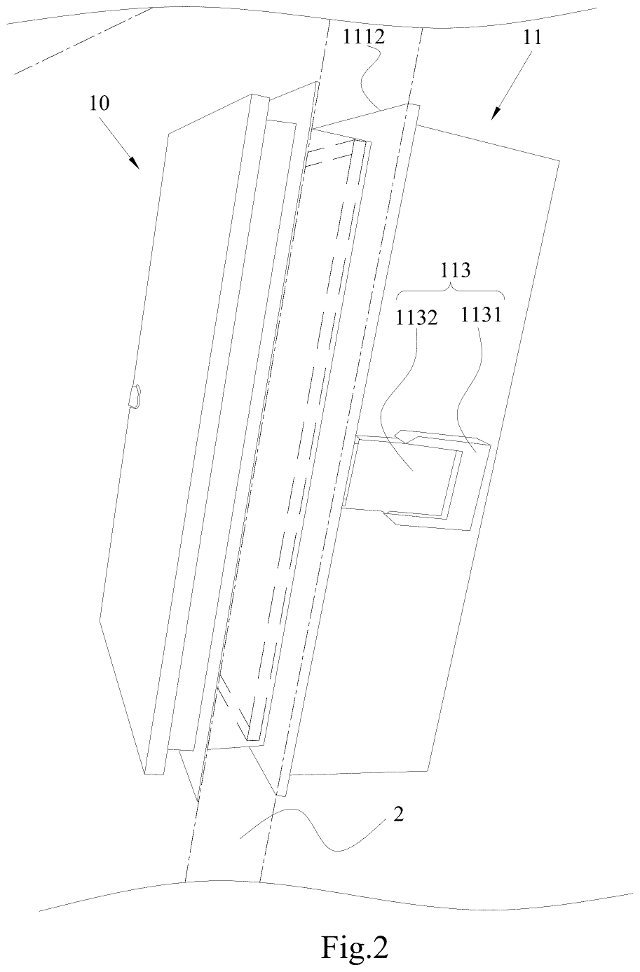

Please refer to FIGS. 1A to 2, which are a structure schematic view of an external component in accordance with a preferred embodiment of the present disclosure, an internal component in accordance with a preferred embodiment of the present disclosure and an application schematic view of a two points access electric vehicle charger cabinet in accordance with a preferred embodiment of the present disclosure. The present invention discloses a two points access electric vehicle charger cabinet 1, which is to be installed at an opening in wall 2, allowing a user to perform charging operations from either the interior or exterior side of the wall 2. The two points access electric vehicle charger cabinet 1 complies with standard building regulations, such as meeting the requirements for wall plastering, felt, and flashing edges. The two points access electric vehicle charger cabinet 1 comprises an external component 10 and an internal component 11. The external component 10 includes a frame-like main body 101 and an external cover 102. The frame-like main body 101 is configured to be installed in the opening of the wall 2 and has a first side 1011 and a second side 1012, which are oppositely arranged. The first side 1011 has an internal opening 10111, while the second side 1012 has an external opening 10121. When the frame-like main body 101 is installed in the opening of wall 2, the first side 1011 faces the interior surface of wall 2. Preferably, the first side 1011 may be designed to be mounted to protrude outward from the interior surface of wall 2. The external cover 102 pivotally installed on the second side 1022 and capable of opening and closing relative to the frame-like main body 101. The external cover 102 and the frame-like main body 101 may be made of materials with better insulation and waterproof properties to withstand weather changes in outdoor environments.

The internal component 11 is assembled within the first side 1011 of the frame-like main body 101 and includes an assembly body 111 and an internal box 112. The assembly body 111 is a frame-like structure designed to be assembled with the first side 1011. The internal box 112 is hinged to the assembly body 111 and can open or close relative to it. The internal box 112 has an accommodating space 1121 for placing a charger 3. When the user is charging from the inside of wall 2, the internal box 112 is opened to use the charger 3. When the user is charging from the outside of wall 2, the outer cover 102 is opened to access the charger 3 located inside the internal box 112 for charging.

Thus, the two points access electric vehicle charger cabinet 1 provides a convenient charging solution that allows access for charging both from the inside of the wall 2, such as a garage, and from the outside of the wall 2, such as a driveway. This effectively solves the limitation of existing chargers, which can only provide unidirectional charging due to their installation location and the length of the power cable.

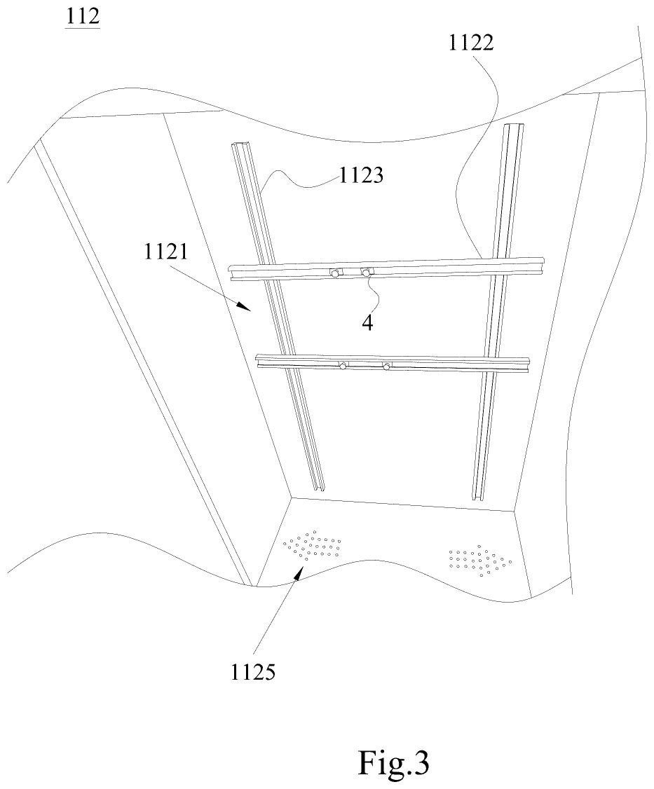

Preferably, please also refer to FIG. 3, which is a partial structure schematic view of an internal box in accordance with a preferred embodiment of the present disclosure. To enhance the stability of the charger 3 when installed in the internal box 112, at least one first guide rail 1122 is provided within the accommodation space 1121 of the internal box 112. The charger 3 is secured to the first guide rail 1122 using at least one screw 4. This allows the charger 3 to be firmly installed in the internal box 112 and enables the position of the charger 3 within the accommodation space 1121 to be adjusted as needed. Furthermore, the first guide rail 1122 can be T-shaped, allowing the screw 4 to slide within the first guide rail 1122, thereby providing a more convenient adjustment function.

In addition to providing the first guide rail 1122 in the accommodation space 1121, in another embodiment, the accommodation space 1121 of the internal box 112 may be provided with at least one first guide rail 1122 and at least one second guide rail 1123. The second guide rail 1123 is securely fixed to the inner surface of the internal box 112, while the first guide rail 1122 is assembled onto the second guide rail 1123 and arranged in a staggered configuration, such as a vertical stagger. The first guide rail 1122 can move along the second guide rail 1123, and the charger 3 is secured to the first guide rail 1122 using at least one screw 4. This structure of the first and second guide rails enhances the flexibility of adjusting the installation position of the charger 3. Based on this structural arrangement, the first guide rail 1122 can also be designed with a T-shaped structure, allowing the screw 4 to slide within the first guide rail 1122, further improving the adjustment flexibility. With the first guide rail 1122, second guide rail 1123, and similar structures, the internal box 112 can accommodate chargers 3 of various sizes and shapes.

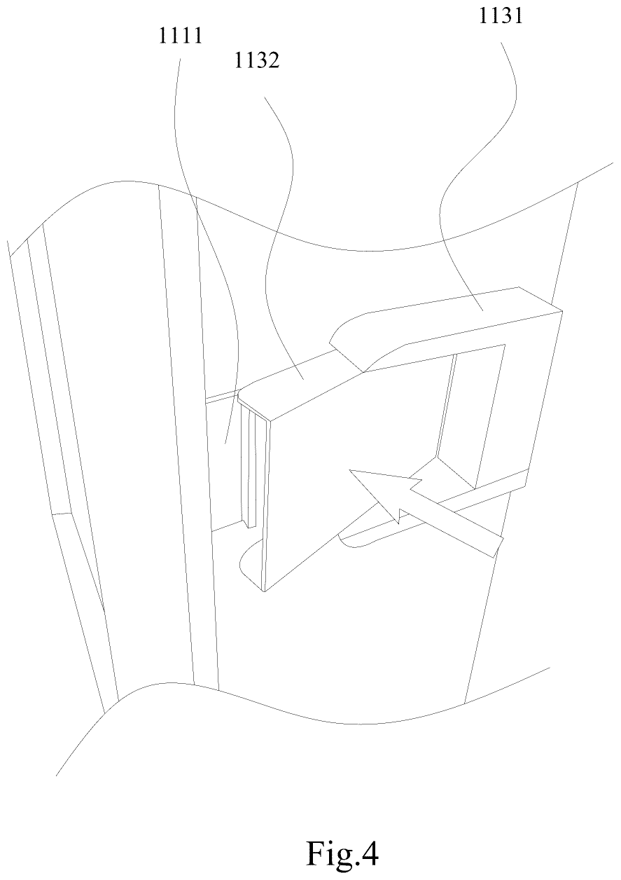

Next, please also refer to FIG. 4, which is a structure schematic view of a switch component in accordance with a preferred embodiment of the present disclosure. The opposite side of the internal box 112, which is pivotally connected to the assembly body 111, is equipped with a switch assembly 113. The composite main body 111 has a corresponding latch component 1111 for the switch assembly 113. The switch assembly 113 includes a base 1131 and an elastic pressing component 1132. The base 1131 is locked into the internal box 112, and one side of the elastic pressing component 1132 is pivotally connected to the base 1131. The elastic pressing component 1132 is hooked onto the latch component 1111, keeping the internal box 112 in a closed state. When the elastic pressing component 1132 is pressed, it can detach from the latch component 1111, allowing the internal box 112 to be opened. In a preferred embodiment, the switch assembly 113 is an independent component from the internal box 112 and is fixed to the internal box 112 using rivets. This design makes the switch assembly 113 harder to tamper with and also more convenient to replace or repair. More specifically, the elastic pressing component 1132 of the switch assembly 113 includes a plate body and a spring. Under normal, un-pressed conditions, the elastic pressing component 1132 is held in a locked state with the latch component 1111 due to the spring's elasticity. When the user presses the elastic pressing component 1132, it detaches from the latch component 1111, thereby unlocking the state.

In a preferred embodiment, the internal box 112 and the assembly body 111 are pivotally connected through at least one hinge component 114. The hinge component 114 includes a movable plate 1141 and a pivot shaft 1142. The pivot shaft 1142 is installed on the internal box 112, and preferably, the pivot shaft 1142 is fixed to the internal box 112 via a fixing plate. One end of the movable plate 1141 is fitted onto the pivot shaft 1142, while the other end is securely attached to the assembly body 111, allowing the pivot shaft 1142 and the movable plate 1141 to pivot relative to each other. Through this hinge component 114, the internal box 112 can be easily and stably rotated open. By positioning the pivot shaft 1142 on the internal box 112 and utilizing the structure of the movable plate 1141, the internal box 112 is enabled to exhibit better rotational unfolding performance. This design ensures that the internal box 112 can fully open and rest against the wall.

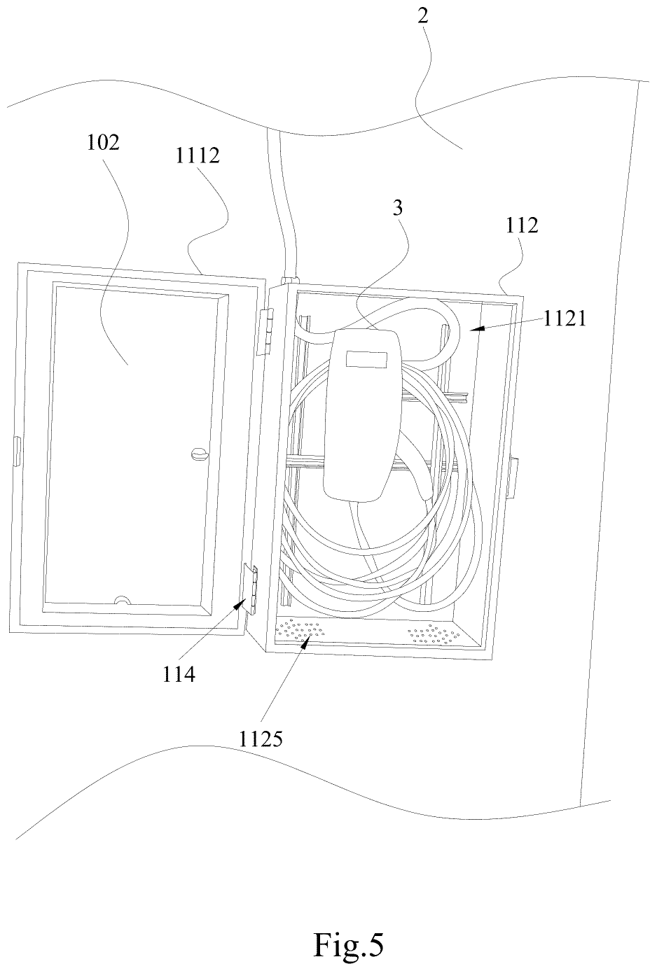

Please refer to FIGS. 1B and 5, and FIG. 5 is an application schematic view of a two points access electric vehicle charger cabinet which is used from the inner side of the wall in accordance with a preferred embodiment of the present disclosure. To enhance user convenience when charging inside the wall 2, i.e., in the garage area, the internal box 112 can be made from a metal material that is magnetically attractable. This allows the internal box 112 to be magnetically attached to a magnet installed on the inner wall surface of wall 2 during charging. This setup helps prevent the internal box 112 from swinging, which could interfere with the charging process, and also protects the charging cable from being pulled or damaged.

Additionally, to facilitate heat dissipation and prevent the charger 3 from being damaged by heat, the top side of the internal box 112 is equipped with a ventilation structure 1124, while the bottom side of the internal box 112 has an air intake structure 1125. This design allows hot air to be expelled from the top while cool air enters from the bottom, effectively preventing wire damage and ensuring the protection of the wiring. Preferably, the ventilation structure 1124 includes a plurality of ventilation holes 11241, and the air intake structure 1125 features a plurality of air intake holes 11251, which are arranged to ensure good airflow. In one preferred embodiment, the ventilation holes 11241 and air intake holes 11251 are grouped into two clusters, expanding the area for air to exit and enter the internal box 112, thereby improving efficiency.

Preferably, the top side of the internal box 112 has a wire hole 1126 located near the pivot point between the internal box 112 and the assembly body 111. This wire hole 1126 allows the power cable of the charger 3 to extend outward and connect to an external power source (not shown in the diagram). By positioning the wire hole 1126 in this location, the power cable only needs to rotate within a radius of less than two inches when the internal box 112 opens or closes, thus minimizing the movement range and preventing the cable from being damaged during rotation.

To further protect the charger 3 placed inside the internal box 112, the edge of the opening of the internal box 112 is equipped with a protective structure 1127. The protective structure 1127 is frame-shaped and extends from the edge of the opening, with its thickness gradually increasing outward from the opening. This design is for ensuring the wire of the charger 3 not getting cut or damage through removing from or restoring into the internal box 112.

Furthermore, to enhance the stability of the assembly of the internal components 11 with wall 2 and effectively prevent gaps from the wall 2's opening from affecting the structure, the perimeter of the assembly body 111 is equipped with a fixed frame 1112. The fixed frame 1112 is designed to be attached firmly to the inner surface of the wall 2, enhancing the structural stability of the assembly body 111 while also offering dustproof and waterproof protection.

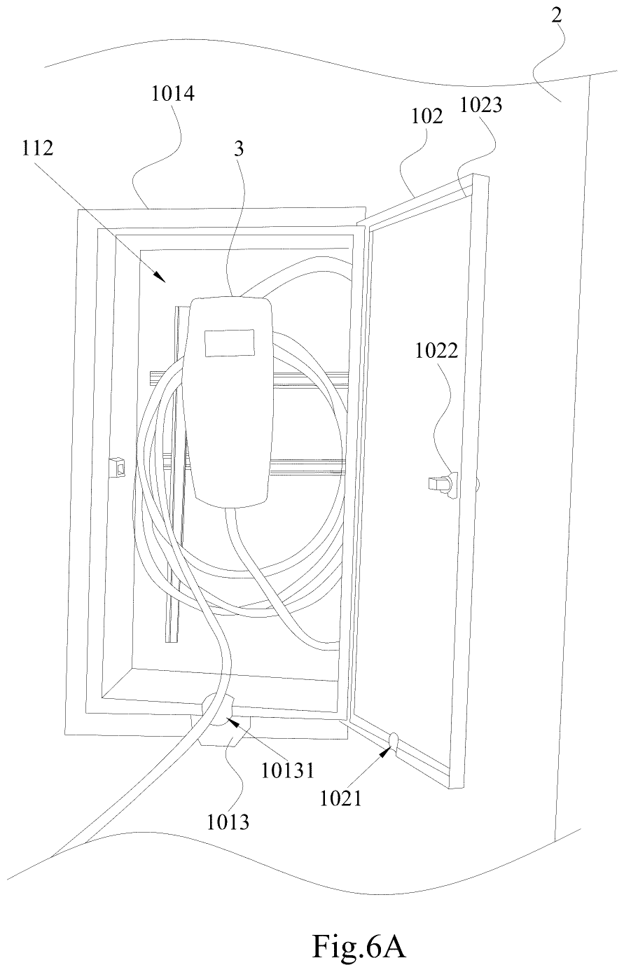

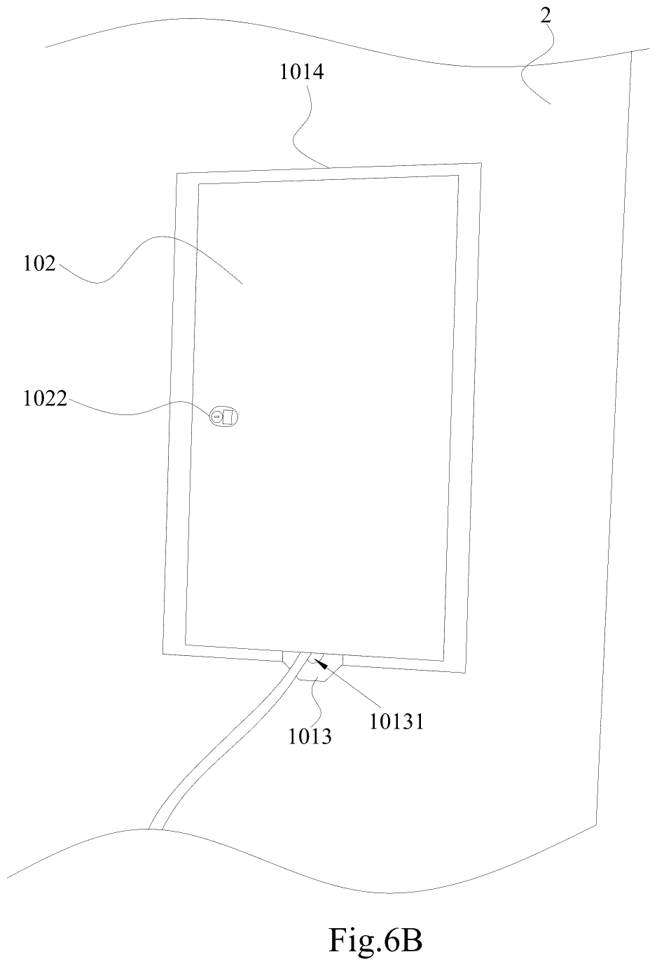

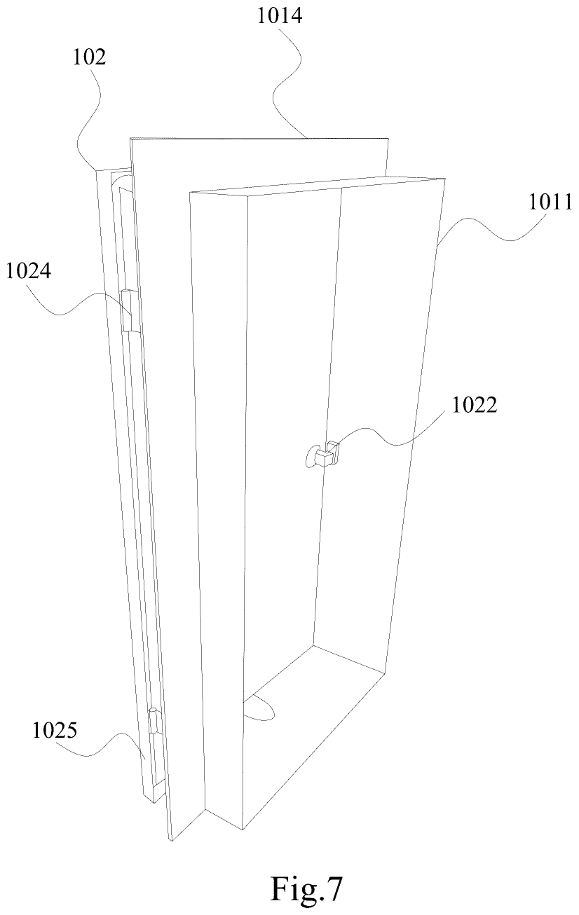

Next, further explanation will be provided regarding the structure of the external component 10, as shown in FIGS. 6A, 6B and 7, which are a first application schematic view of a two points access electric vehicle charger cabinet which is used from the outer side of the wall in accordance with a preferred embodiment of the present disclosure, a second application schematic view of a two points access electric vehicle charger cabinet which is used from the outer side of the wall in accordance with a preferred embodiment of the present disclosure and a structure schematic view of an external component which is closing in accordance with a preferred embodiment of the present disclosure. In one embodiment, the bottom side of the second side 1012 is equipped with a cable guide structure 1013. This cable guide structure 1013 extends from the bottom surface of the second side part 1012 and features a guide groove 10131 to temporarily secure the power cable of the charger 3 during charging. This allows users to charge the vehicle from the exterior side of the wall 2, providing a temporary storage area for the power cable and effectively securing the charging connector's position. Furthermore, the bottom side of the external cover 102 has a perforation 1021 corresponding to the guide groove 10131, allowing the charger's power cable to pass through. As a result, the external cover 102 can be closed during the charging process while still allowing the power cable of the charger 3 to be smoothly extended to the outside, preventing potential damage caused by exposure to harsh weather. Additionally, for enhanced security, the external cover 102 is equipped with a lock 1022 that secures the external cover 102 to the frame-like body 101 when closed.

Given that the external component 10 of the two points access electric vehicle charger cabinet 1 is located in the outdoor space after installation on the wall 2, special attention must be paid to waterproofing and dustproofing. In one embodiment, the internal bottom surface of the frame-like body 101 is slanted from the inner opening 10111 side toward the outer opening 10112 side. This slight elevation of the internal bottom surface of the frame-like body 101 prevents water from seeping into the internal components 11 after entering the body, as the water will flow outwards instead.

Additionally, a waterproof frame 1014 is installed around the perimeter of the second side part 1012. This waterproof frame 1014 is designed to fit against the outer surface of wall 2, preventing water ingress and effectively channeling water away from the second side part 1012 toward the ground.

Regarding the waterproof design of the external cover 102, the interior surface of the external cover 102 is equipped with a waterproof gasket 1023. The waterproof gasket 1023 is in a frame shape and is compressed against the outer edge of the second side part 1012 when the external cover 102 is closed. This design further prevents water from entering the frame-like body 101, especially during inclement weather, ensuring an excellent waterproof effect. Notably, the waterproof features of the external component 10 can individually exist or be combined in the two points access electric vehicle charger cabinet 1, offering either two or three of these technical features.

Regarding the pivot connection structure between the external cover 102 and the frame-like body 101, a preferred embodiment is proposed. The external cover 102 is pivotally connected to the frame-like body 101 via at least one pivot member 1024. The external cover 102 includes a baffle 1025 that extends from its edge. One side of the pivot connection part 1024 is attached to the stopper plate 1025, while the other side is connected to the second side part 1012, with the pivot connection part 1024 hidden between the stopper plate 1025 and the frame-like body 101. This arrangement effectively conceals the pivot connection part 1024, preventing unauthorized disassembly and enhancing security. It also provides some protection to the pivot connection part from weather-related damage. The specific implementation of the pivot connection part 1024 could include a structure with a rotating shaft and a locking plate, with one part welded to the external cover 102 and the other locked from the side of the frame-like body 101.

In summary, the two points access electric vehicle charger cabinet of this invention presents an innovative solution to current electric vehicle charging needs. It not only thoroughly addresses the limitations of traditional unidirectional charging setups but also provides users with a more flexible, safe, and efficient charging experience. The unique bidirectional access design allows for convenient operation from both inside and outside the garage. Whether the vehicle is parked inside the garage or on the driveway, charging can be easily performed, greatly enhancing usability. Moreover, the internal box's guide rail, along with the T-shaped structure and movable screws, considers various differences in the size, shape, and brand of chargers. This adaptable structure offers a seamless solution for a variety of chargers in the market, eliminating the need for extra installation effort and demonstrating the product's outstanding adaptability. The invention also features a structural design that hides the pivot connection parts and incorporates waterproof frames, enhancing the waterproof and dustproof properties as well as the security of the charging cabinet, ensuring stable operation in various environments. The ventilation and intake designs provide excellent heat dissipation throughout the charging process, effectively preventing overheating and prolonging the lifespan of the charging equipment, while maintaining charging efficiency and safety. The two points access electric vehicle charger cabinet also takes installation and usage safety into account. The external components are equipped with reliable anti-theft locks, while the internal switching components are tamper-proof and offer excellent locking stability and ease of access. Additionally, through the careful selection of materials for the internal compartment, users can securely fix the compartment to the wall with magnets, preventing unnecessary movement that could disrupt charging or cause cable strain. Overall, the two points access electric vehicle charger cabinet not only solves the limitations of traditional unidirectional charging stations but also significantly improves user experience through its remarkable flexibility, compatibility, and safety. Every detail of the design reflects the product's exceptional quality, making it a breakthrough improvement and upgrade in existing technology. This charging cabinet undoubtedly offers electric vehicle owners a safer, more convenient, and efficient charging solution, establishing it as a leading innovation in the charging equipment market.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A two points access electric vehicle charger cabinet, configured to be installed in an opening of a wall, allowing a user to perform charging operations from either the interior or exterior side of the wall, comprising:
an external component, comprising:
a frame-like main body, configured to be installed in the opening of the wall, and having a first side and a second side disposed oppositely, wherein the first side has an inner opening, and the second side has an outer opening, with the first side facing the interior surface of the wall when the frame-like main body is installed in the wall opening; and
an external cover, pivotally installed on the second side and capable of opening and closing relative to the frame-like main body; and
an internal component, assembled to the first side of the external component, comprising:
an assembly body, having a frame-like structure configured to assemble with the first side; and
an internal box, pivotally installed on the assembly body and capable of opening and closing relative to the assembly body, the internal box having an accommodating space for accommodating a charger;
wherein, when the user performs charging from the interior side of the wall, the internal box is opened to access the charger; when the user performs charging from the exterior side of the wall, the external cover is opened to retrieve the charger located in the internal box for charging.

2. The two points access electric vehicle charger cabinet of claim 1, wherein at least one first guide rail is installed within the accommodating space, and the charger is secured to the first guide rail by at least one screw.

3. The two points access electric vehicle charger cabinet as described in claim 2, wherein the first guide rail has a T-shape, allowing the screw to slide within the first guide rail.

4. The two points access electric vehicle charger cabinet as described in claim 1, wherein at least one first guide rail and at least one second guide rail are installed within the accommodating space, with the second guide rail being fixed to the inner surface of the internal box; the first guide rail is assembled onto the second guide rail in a staggered arrangement, allowing the first guide rail to move along the second guide rail, and the charger is secured to the first guide rail by at least one screw.

5. The two points access electric vehicle charger cabinet as described in claim 4, wherein the first guide rail has a T-shape, allowing the screw to slide within the first guide rail.

6. The two points access electric vehicle charger cabinet as described in claim 1, wherein the opposite side of the internal box, which is pivotally connected to the assembly body is equipped with a switch assembly, and the assembly body has a corresponding latch component; the switch component includes a base and an elastic pressing member, where the base is fixed to the internal box, and one side of the elastic pressing member is pivotally connected to the base; the elastic pressing member hooks onto the latch component, securing the internal box in a closed state, and can be released from the latch component when pressed, allowing the internal box to open.

7. The two points access electric vehicle charger cabinet as described in claim 1, wherein the bottom side of the second side includes a cable guide structure, which extends from the bottom side of the second side and includes a guide groove to temporarily secure the charging cable of the charger within the guide groove during charging.

8. The two points access electric vehicle charger cabinet as described in claim 7, wherein the bottom side of the external cover has a perforation corresponding to the guide groove, allowing the charger's cable to pass through.

9. The two points access electric vehicle charger cabinet as described in claim 8, wherein the external cover is equipped with a lock to lock onto the frame-like main body when the external cover is closed.

10. The two points access electric vehicle charger cabinet as described in claim 1, wherein the top side of the internal box includes a wire hole located near the pivotal connection between the internal box and the assembly body, allowing the charger's power cable to be extended outward and electrically connected to an external power source.

11. The two points access electric vehicle charger cabinet as described in claim 1, wherein the internal box and the assembly body are pivotally connected through at least one hinge component, which includes a movable plate and a pivot shaft, with the pivot shaft installed on the internal box; one end of the movable plate is fitted onto the pivot shaft, and the other end is fixed to the assembly body, enabling the pivot shaft and the movable plate to pivot relative to each other.

12. The two points access electric vehicle charger cabinet as described in claim 1, wherein the internal box is made from a metal material that is magnetically attractable.

13. The two points access electric vehicle charger cabinet as described in claim 1, wherein the inner bottom surface of the frame-like main body slopes from the inner opening side towards the outer opening side.

14. The two points access electric vehicle charger cabinet as described in claim 1, wherein the periphery of the second side includes a waterproof frame, designed to fit against the outer wall surface.

15. The two points access electric vehicle charger cabinet as described in claim 1, wherein the inner surface of the external cover is equipped with a waterproof gasket, structured in a frame-like shape to press against the edge of the outer opening when the external cover is closed.

16. The two points access electric vehicle charger cabinet as described in claim 1, wherein the top side of the internal box includes a ventilation structure, and the bottom side includes an air intake structure.

17. The two points access electric vehicle charger cabinet as described in claim 16, wherein the ventilation structure includes a plurality of ventilation holes, and the air intake structure includes a plurality of air intake holes.

18. The two points access electric vehicle charger cabinet as described in claim 1, wherein the edge of the internal box opening has a protective structure, which is frame-shaped and extends from the edge of the internal box opening, with the thickness gradually increasing outward.

19. The two points access electric vehicle charger cabinet as described in claim 1, wherein the external cover is pivotally connected to the frame-like main body through at least one pivot member and includes a baffle; the baffle extends from the edge of the external cover, with one side of the pivot member connected to the baffle and the other side connected to the second side, allowing the pivot member to be hidden between the baffle and the frame-like main body.

20. The two points access electric vehicle charger cabinet as described in claim 1, wherein the periphery of the assembly body includes a fixed frame designed to be secured against the inner wall surface.
